(19) United States
(12) Patent Application Publication
(10) Pub. No.: US 2016/0139069 A1
(43) Pub. Date: May 19, 2016

(54) LARGE SCALE, LOW COST NANOSENSOR, NANO-NEEDLE, AND NANOPUMP ARRAYS

(71) Applicant: Neem Scientific, Inc., San Diego, CA (US)

(72) Inventor: Deli Wang, San Diego, CA (US)

(21) Appl. No.: 14/941,506

(22) Filed: Nov. 13, 2015

Related U.S. Application Data
(60) Provisional application No. 62/079,356, filed on Nov. 13, 2014.

(51) Int. Cl. G01N 27/02; B01L 3/00

(52) U.S. Cl. CPC G01N 27/02; B01L 3/50273; B01L 3/502715; B01L 2400/0427; B01L 2300/16; B01L 2300/0838; B01L 2300/165

(57) ABSTRACT

A nanoscale probe includes a substrate and a pair of nanoscale wires each having a first end disposed on the substrate and a second end. The second ends of each nanoscale wire are in contact with one another such that the pair of nanoscale wires form a bridge extending over the substrate. The nanoscale wires may be electrically connected to electrodes residing on the substrate. The electrodes, in turn, are connected to an active electronic device such as a readout device or microprocessor formed in the substrate on which the probe is located. In this way a property of the nanoscale wires, and thus of the cell, may be determined.

### BACKGROUND

Nanoelectronic sensors and other devices offer substantial potential for interrogating biological systems due to their very high sensitivity and precision in testing and positioning because of their small dimensions, large surface area to volume ratio and large variety of material properties. Such devices offer a small and scalable probe that can be coupled with tissues, cells, single cells, and even single molecules. One type of probe that has been developed for this purpose employs nanoscale wires or tubes that can be directly inserted into a cell to determine a property of the cell, e.g., an electrical property. In some cases, only the tip of the nanoscale wire is inserted into the cell; this tip may be very small relative to the size of the cell, allowing for precise study. Moreover, because of their very small size, (typically smaller than 200 nm in dimension), the mechanical insertion of the probes do not necessarily cause noticeable damage to the cell membrane or other biological system being interrogated, thus enabling precise study of living cell samples, which includes even the monitoring of the live cell in real time. The large choices of probe materials and properties allow the nanowire devices to function as chemical sensors, light detectors, pressure sensors, neuronal probes, etc.

### SUMMARY

In one aspect, a nanoscale probe is provided that includes a substrate and a pair of nanoscale wires each having a first end disposed on the substrate and a second end. The second ends of each nanoscale wire are in contact with one another such that the pair of nanoscale wires form a bridge extending over the substrate.

The nanoscale wires may be electrically connected to electrodes residing on the substrate. The electrodes, in turn, are connected to an active electronic device such as a readout device or microprocessor formed in the substrate on which the probe is located. In this way a property of the nanoscale wires, and thus of the cell, may be determined. The microprocessor may also be used to control the probe in various ways such as by turning it on and off, for example. Such probes, which may also be used for studying samples other than cells, may also comprise nanotubes instead of nanowires. The nanotubes may be used as a delivery system to deliver chemicals (e.g., drugs) or electric pulses, for example, to the cell. The use of the probe as a sensor and as a delivery system may take place concurrently or at different times.

In another aspect, a method of forming a nanoscale probe is provided. In accordance with the method, a dielectric layer is formed on a substrate and a photoresist mask is applied over the substrate. An isotropic etch is performed on the dielectric layer such that a remaining portion of the dielectric layer defines a tapered support structure located under the photoresist mask. The photoresist mask is removed and a shadow mask is applied over the tapered support structure. The shadow mask has at least a first pair of nanoscale apertures that are aligned with respect to the tapered support structure such that material deposited through each of the nanoscale apertures form a nanoscale wire on a different surface of the tapered support structure. Material is deposited through the nanoscale apertures to form the first pair of nanoscale wires.

In yet another aspect, a nanoscale needle or pump is provided that includes a substrate and a dielectric layer disposed on the substrate. A conductive nanotube has a base disposed on the dielectric layer and an opening disposed at an end of the conductive nanotube remote from the base such that the opening is adapted to be in fluidic communication with a sample. A hydrophobic coating is disposed on an outer surface of the conductive nanotube. An electrode is disposed on the dielectric layer and spaced apart from the conductive nanotube.

In a further aspect, a method for extracting fluid from a sample using a nanotube is provided. In accordance with the method, a nanotube is inserted into a sample. The nanotube has a conductive sidewall and a hydrophobic coating disposed on the conductive sidewall such that an opening of the nanotube is in fluidic communication with an interior of the sample. After the nanotube is inserted, a bias is applied between the conductive sidewall and a counter-electrode such that fluid is drawn into an interior of the nanotube through the opening at least in part in accordance with an electrowetting effect. While the bias continues to be applied, the nanotube is withdrawn from the sample after the fluid is draw into the interior. The bias is then removed to thereby expel the fluid from the interior of the nanotube.

### BRIEF DESCRIPTION OF THE DRAWINGS

FIG. 1 shows a top view of one example of a sensor array.

FIGS. 2 and 3 show side views of the sensor array of FIG. 1 taken along lines 2-2 and 3-3, respectively, in FIG. 1

FIG. 4 is a perspective view showing an array of individual sensors that may be formed on a single substrate or wafer.

FIGS. 5A-5L show one example of a sequence of process steps that may be employed to fabricate the sensor array shown in FIGS. 1-4.

FIG. 6 shows a top view of one example of a shadow mask that may be employed in the process of FIG. 5.

FIG. 7 shows a cross-section through one example of the shadow mask.

FIG. 8 shows a side view of an alternative example of the shadow mask.

FIG. 9A illustrates an alternative process that may be used to fabricate the nanowires of the sensor using photolithography or electron beam lithography methods and FIGS. 9B and 9C show a SEM image of Ti/Au bilayer nanowires fabricated using electron beam lithography.

FIG. 10 shows one example of a sensor in which the nanowires each comprise three different material layers.

FIG. 11A shows one example of a tip of a nanostructure bridge that includes a semiconductor sensor as the uppermost layer of the tip and an insulating layer below the semiconductor sensor.

FIG. 11B shows another example of a tip of a nanostructure bridge that includes a metal nano thermometer as the uppermost layer of the tip, followed below by an insulator layer and a layer that serves as a metal nano-heater.

FIG. 12 show one example of a sensor in which the nanowires undergo further processing to form nanotubes that may be used to remove fluids from and/or deliver fluids to a cell or other sample.

FIG. 13 shows one example of a sensor in which nanotubes are bonded to a control stage that allows the nanotubes to communicate with one or more microfluidic pumps.

FIG. 14 shows a side view of one example of a nano-needle.

FIGS. 15 and 16 each show a cross-sectional view of the nano-needle of FIG. 14 in which the interior of the nanotube is visible.

FIGS. 17-21 illustrate a sequence of process steps in which the nano-needle shown in FIGS. 14-16 is used to extract fluid from a cell.

FIG. 22 is a top view of an array of the nano-needles shown in FIGS. 14-16, which may be formed on a single substrate or wafer 155.

FIG. 23 shows a cross-sectional view of one embodiment of the nano-needle in which its interior is completely hollow.

### DETAILED DESCRIPTION

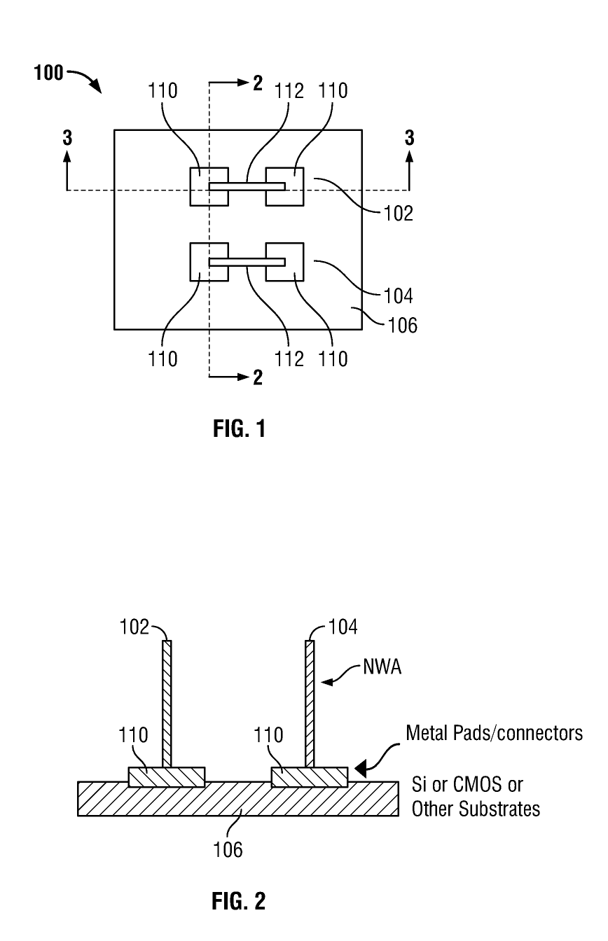

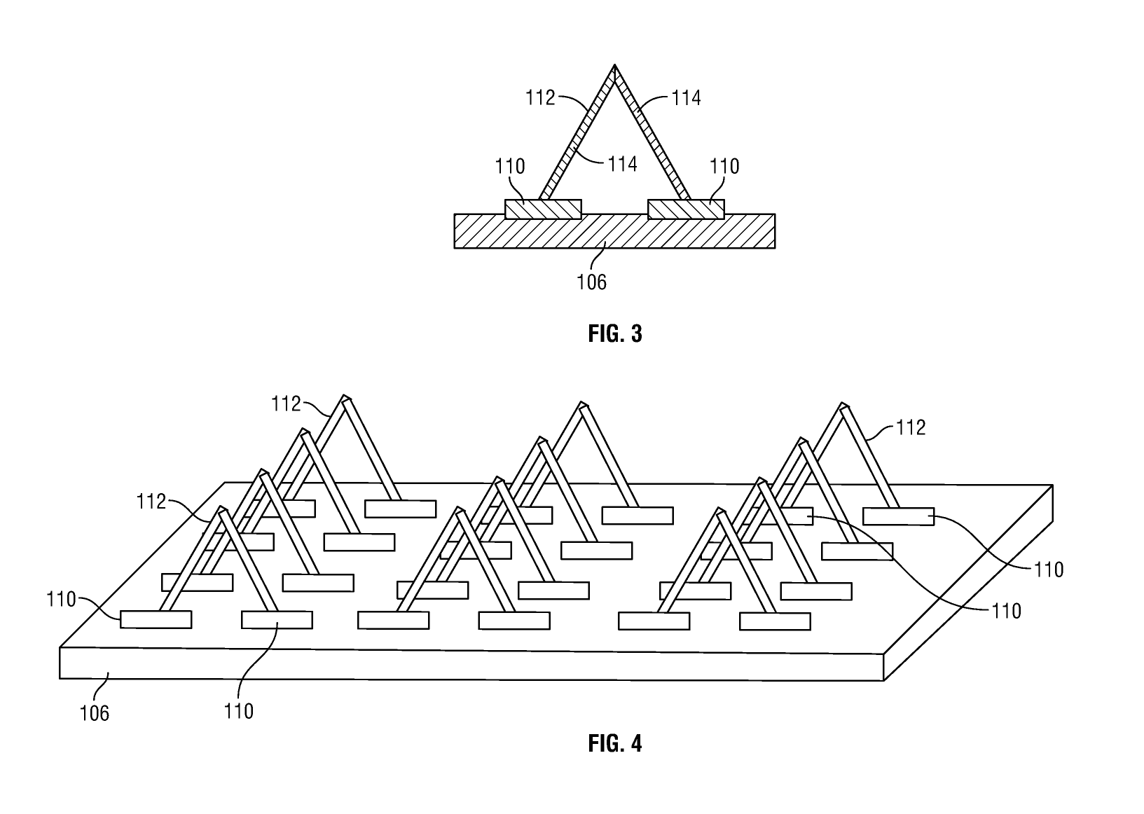

FIG. 1 shows a top view of one example of a sensor array 100. FIGS. 2 and 3 show orthogonal side views of the sensor array 100 taken along lines 2-2 and 3-3, respectively, in FIG. 1. In this example two sensors 102 and 104 are formed on a common substrate or wafer 106. More generally, any number of sensors may be formed on a common substrate. The substrate 106 may be a Si, CMOS or polymeric substrate, for example, and may contain measurement electronics such as a microprocessor or the like for controlling the sensors and for receiving data from the sensors.

As used herein, the terms “wafer” and “substrate” each refer to a free-standing, self-supporting structure and is not to be construed as a thin film layer that is formed on a free-standing, self-supporting structure.

Each sensor 102 and 104 includes a pair of electrode pads 110 and a nanowire bridge 112 that has end portions that each terminate on one of the electrode pads 110. The electrode pads 110, which may be formed from one or more metals, doped semiconductors or other conductive materials, establish communication between the nanowire bridge 112 and the underlying circuitry of the active device formed in the substrate 106.

The nanowire bridge 112 includes a pair of nanoscale wires (referred to herein as “nanowires”) 114 that may be formed from metals, semiconductors, insulators or any combination thereof. In some aspects, the nanowires 114 are used to determine a property of the environment in and/or around the nanowires, e.g., a chemical property, an electrical property, a physical property, a biological property, etc. Such determination may be qualitative and/or quantitative. For example, in one set of embodiments, the nanowires 114 may be responsive to an electrical property such as voltage or electric potential. Other examples of electrical properties that can be determined include resistance, resistivity, conductance, conductivity, impendence, or the like. In some embodiments the nanowires 114 may be optoelectrically active so that they are responsive to environmental changes in the intensity and/or spectral composition of light. In some embodiments the nanowires 114 may be chemically or electrochemically active so that they are responsive to environmental changes in electrical charges related chemical reactions.

While the nanowire bridge 112 shown in FIG. 3 is configured as a triangular arch, more generally it may have any desired shape. For example, in various embodiments the nanowire bridge 112 may configured, without limitation, as a Roman arch, a bell arch, a round arch, a Lancet (Gothic) arch or an Ogee arch.

In general, a nanoscale wire is a wire that at any point along its length has at least one cross-sectional dimension and, in some embodiments, two orthogonal cross-sectional dimensions (e.g., a diameter) of less than 1 micrometer, less than about 500 nm, less than about 200 nm, less than about 150 nm, less than about 100 nm, less than about 70, less than about 50 nm, less than about 20 nm, less than about 10 nm, less than about 5 nm, than about 2 nm, or less than about 1 nm. In the case of a nanotube, the shell may have any suitable thickness, e.g., less than about 500 nm, less than about 200 nm, less than about 150 nm, less than about 100 nm, less than about 70, less than about 50 nm, less than about 20 nm, less than about 10 nm, less than about 5 nm, than about 2 nm, or less than about 1 nm.

In some particular examples the sensors 102 and 104 described herein may have the following range of dimensions. The nanowire bridge 112 may have a height ranging from 0.1-5 microns or from 5-100 microns. The distance between the electrode pads 110 for each sensor may range from 50-500 nms or from 500-20,000 nms. The electrode pads 110, which may have any suitable shape (e.g., square, circular), may range in diameter from 10-5000 nms or from 500-100,000 nms.

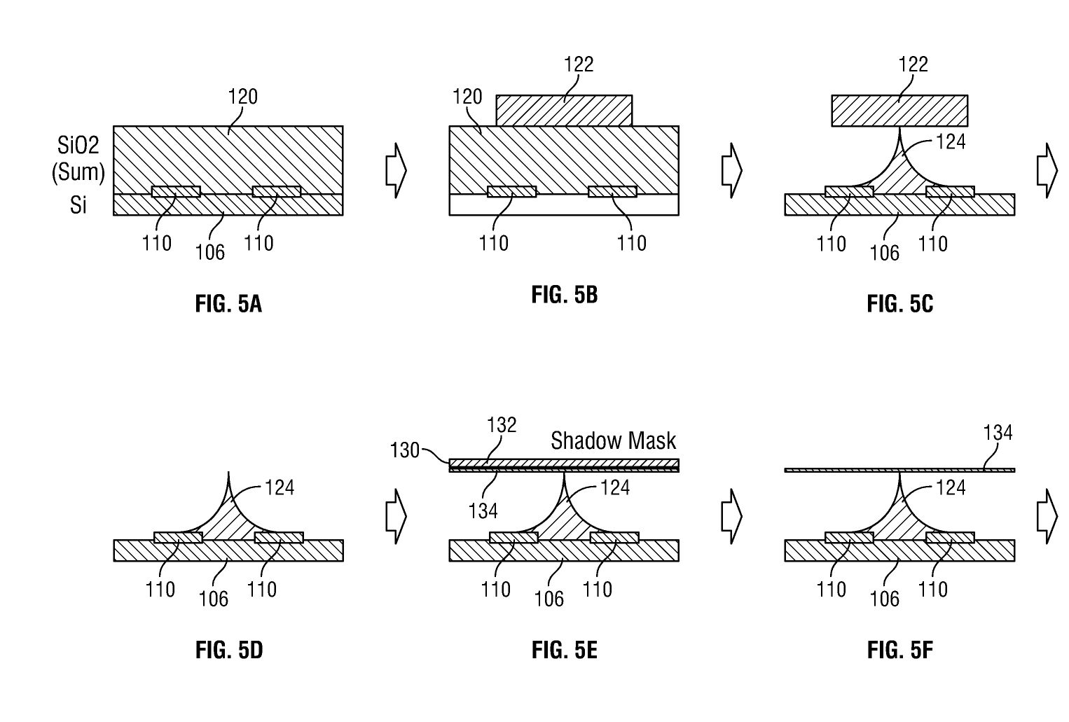

FIG. 4 is a perspective view showing an array of individual sensors that may be formed on a single substrate or wafer. In this example the sensors are formed in array of columns extending in the y-direction and rows extending in the x-direction. More generally, however, the individual sensors may be distributed on the substrate in any desired arrangement. The sensors may be individually selectively addressable using the underlying circuitry of the active electronic device.

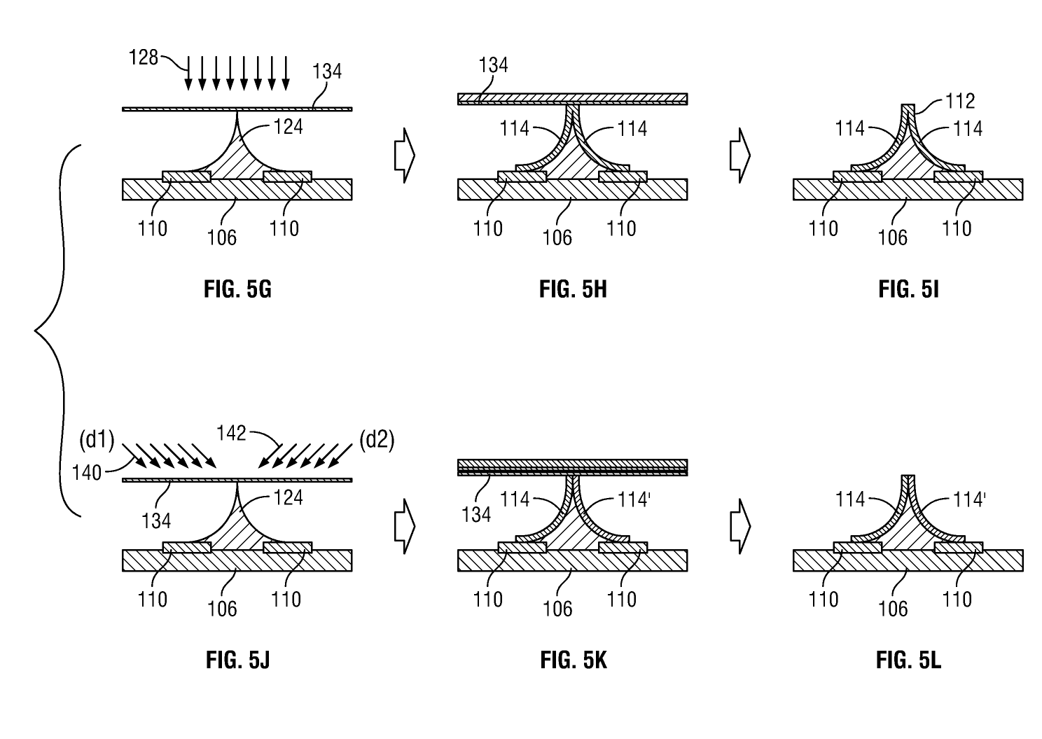

FIGS. 5A-5L show one example of a sequence of process steps that may be employed to fabricate the sensor array 100 shown in FIGS. 1-4. For simplicity only a single sensor is illustrated. However, this process more generally may be used to simultaneously form an array of sensors such as shown in FIG. 4. Furthermore, various details such as the particular sequence of steps and the types of masks that are employed may vary from application to application and are not limited to the particular examples shown in FIG. 5. For instance, in those implementations in which different types of sensors are being formed on a common substrate or wafer, different types of masks may be used in different sequences in order to produce the different sensors.

FIG. 5A shows a Si or CMOS substrate 106 having an embedded active device and a pair of electrode pads 110. The substrate 106 and pads 110 may be fabricated in accordance with any suitable techniques. A dielectric layer 120 (e.g., SiO₂, polysilicon, photoresist) is formed on the substrate 106. The dielectric layer 120 has a thickness corresponding to the desired height of the nanowire bridge that is to be formed. A photoresist mask 122 is formed on the dielectric layer 120 as shown in FIG. 5B. The mask 122, which may be fabricated in accordance with conventional techniques, extends over the pads 110 as shown. Next, as shown in FIG. 5C, an isotropic wet etch using a buffered oxide etch (BOE), for example, is performed to remove portions of the dielectric layer 120. Because the etch is isotropic and thus etches at an equal rate in both the horizontal and vertical directions, the remaining portion of the dielectric layer after etching is a tapered support structure 124 with the apex of the taper structure centered under the mask 122. As FIG. 5C shows, the base of the tapered support structure 124 extends over both of the electrode pads 110. After etching, the mask 122 is removed in FIG. 5D.

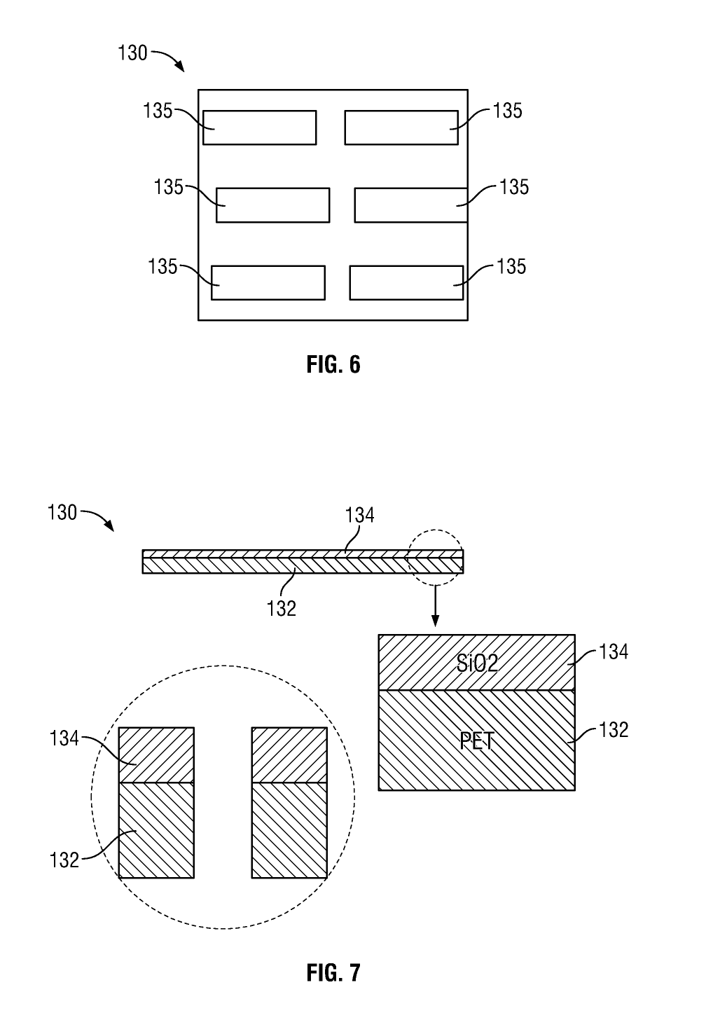

In FIG. 5E a shadow mask 130 is placed over the substrate 106. As seen in the top view of the shadow mask 130 shown in FIG. 6, the shadow mask 130 includes apertures 135 through which material is deposited to fabricate the nanowire bridge on the tapered support structure 124. Each aperture 135 defines a nanowire of the nanowire bridge. The shadow mask 130 in FIG. 6 includes three pairs of apertures for producing three nanowire bridges. The length of the apertures 135 matches the spacing between the electrode pads 110. In one embodiment, the shadow mask 130 includes a thin dielectric layer 134 (e.g., SiO₂) and a thicker handling layer 130 (e.g. a polymer such as PET) that provides mechanical strength. After the shadow mask 130 is properly aligned on the substrate 106 the handling layer 132 may be removed in FIG. 5F using, for example, an etching process such as reactive ion etching.

A deposition process 128 (e.g. evaporation) is then used in FIG. 5G to deposit the material that forms the nanowires 114 of the nanostructure bridge 112. If the resulting nanowires comprise a single material then the deposition process may be formed in a single process step. Alternatively, if the nanowires are heterostructures, multiple deposition steps may be performed. FIG. 5H shows the nanowires 114 formed on the tapered support structure 124 after deposition. Finally, another etching process is performed in FIG. 5I to remove the dielectric layer 134 of the shadow mask 130 and the tapered support structure 124 underlying the nanostructure bridge 112.

In the sequence of process steps described above the two nanowires 114 that make up a single nanostructure bridge 112 may be formed from the same material or materials. However, in other embodiments each nanowire 114 may comprise a different material or materials. This may be accomplished, for example, by replacing the sequence of processing steps shown in FIGS. 5G-5I with the sequence of processing steps 5J-5L. In FIG. 5J the substrate 106 and shadow mask 130 are tilted with respect to the sources of evaporative material and two different evaporation processes 140 and 142 are performed, each forming one of the nanowires 114 and 114′ shown in FIG. 5K. Similar to the step shown in FIG. SI, another etching process is performed in FIG. 5L to remove the dielectric layer 134 of the shadow mask 130 and the tapered support structure 124 underlying the nanostructure bridge 112. By forming the nanostructure bridge 112 from two different nanowires, devices such as p/n diodes and thermocouples, for example, may be formed.

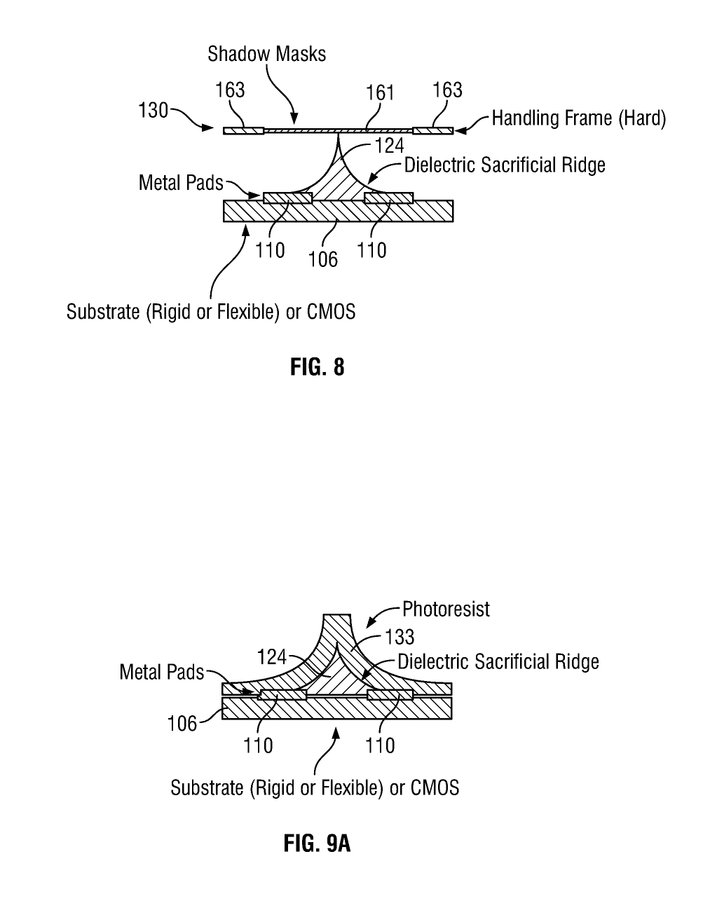

As previously mentioned, the shadow mask 130 may include a polymer handling layer 132 on which a dielectric layer 134 is formed (see FIG. 7). The overall footprint of the shadow mask 130 may be the same as the footprint of the substrate or wafer 106 on which the sensors are formed. In some particular embodiments the apertures in the shadow mask 130 may be patterned using a technique such as laser interference patterning (LIP), electron beam lithography (EBL) or nanoimprint lithography (NIL). The apertures may then be formed from the pattern using reactive ion etching or wet etching, for example, to define nanoscale lines having a width, in some examples, between 10-1,000 nm and more particularly between 200-300 nm.

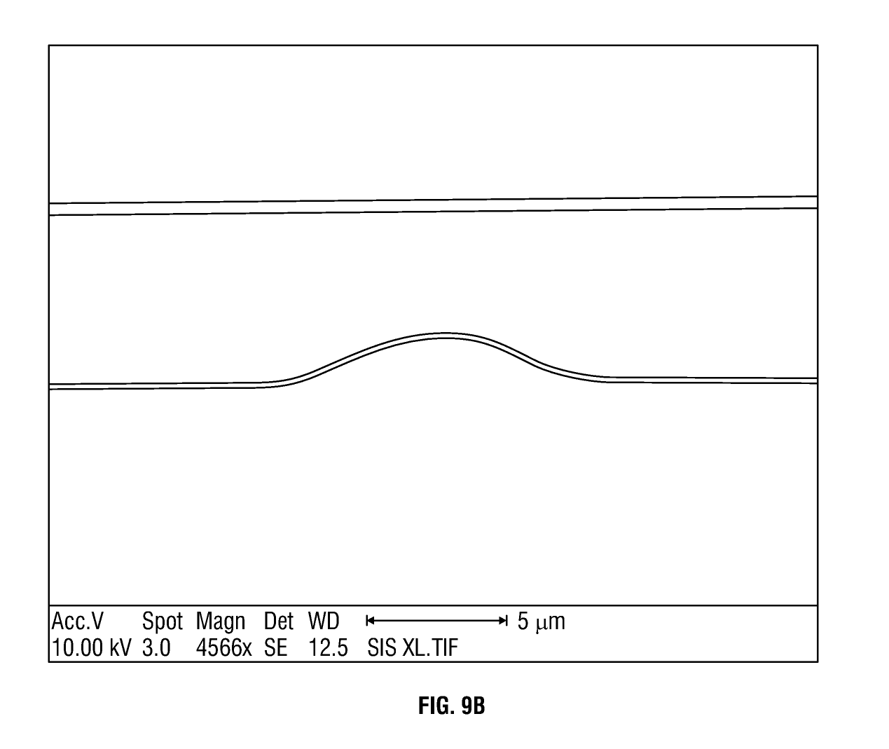

In one alternative embodiment shown in FIG. 8, the shadow mask 130 may be a mask formed from a thin membrane 161 on a supporting frame 163. The thin membrane 161 can be a dielectric or metallic material such as, without limitation, SiNx, Si, and SiO₂. The supporting frame 163 provides mechanical strength for handling, which allows this mask to be used multiple times, with a cleaning process generally being employed after each use. The cleaning process may include a highly selective etching to remove the deposited materials while leaving the thin membrane intact.

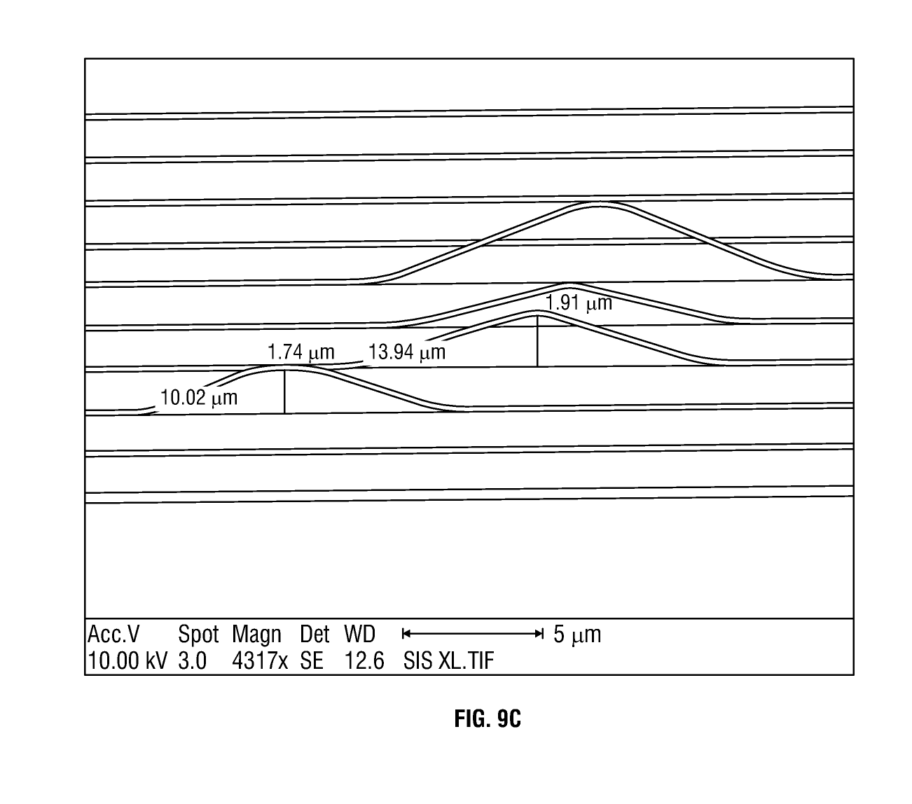

In one alternative embodiment the nanowire 114 can be also fabricated using standard photolithography or electron beam lithography methods as shown in FIG. 9A, where a photoresist layer 133 is coated on the tapered support structure. A light or electron beam exposure process, followed by development of the photoresist, may be used to generate patterns on the photoresist-coated substrate. After the deposition and lift-off processes, nanowires 114 are created on the tapered support structure 124. A free standing nanowire 114 array can be obtained after selective removal of the tapered support structure 124. FIGS. 9B and 9C show a SEM image of Ti/Au bilayer nanowires fabricated using e-beam lithography using PMMA as the photoresist and after removal of the SiO₂ tapered support structure 124.

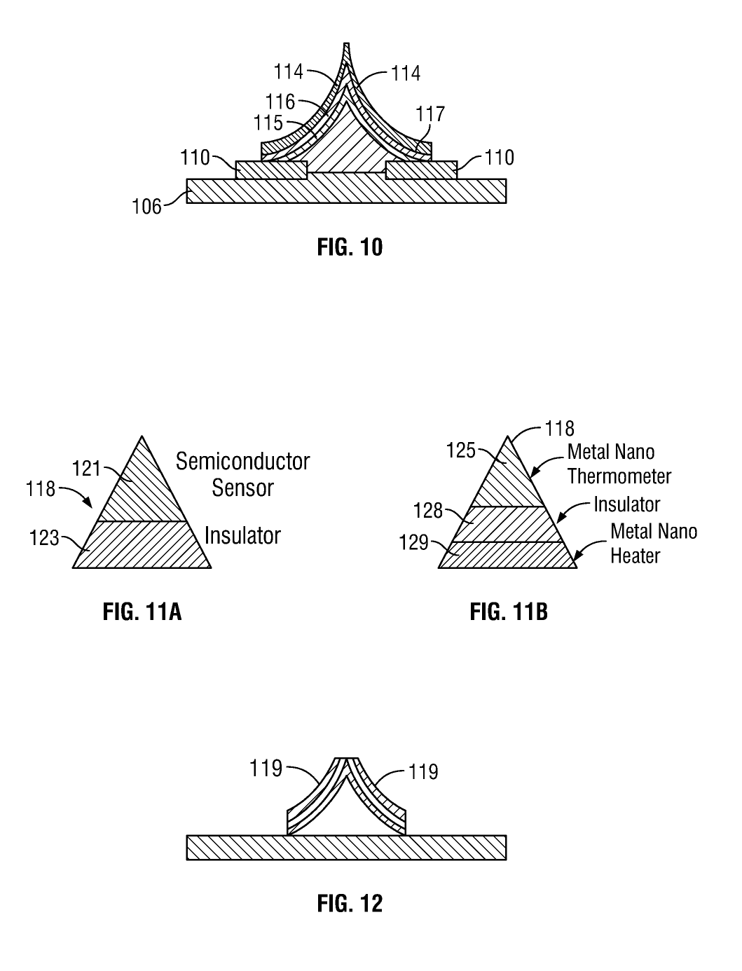

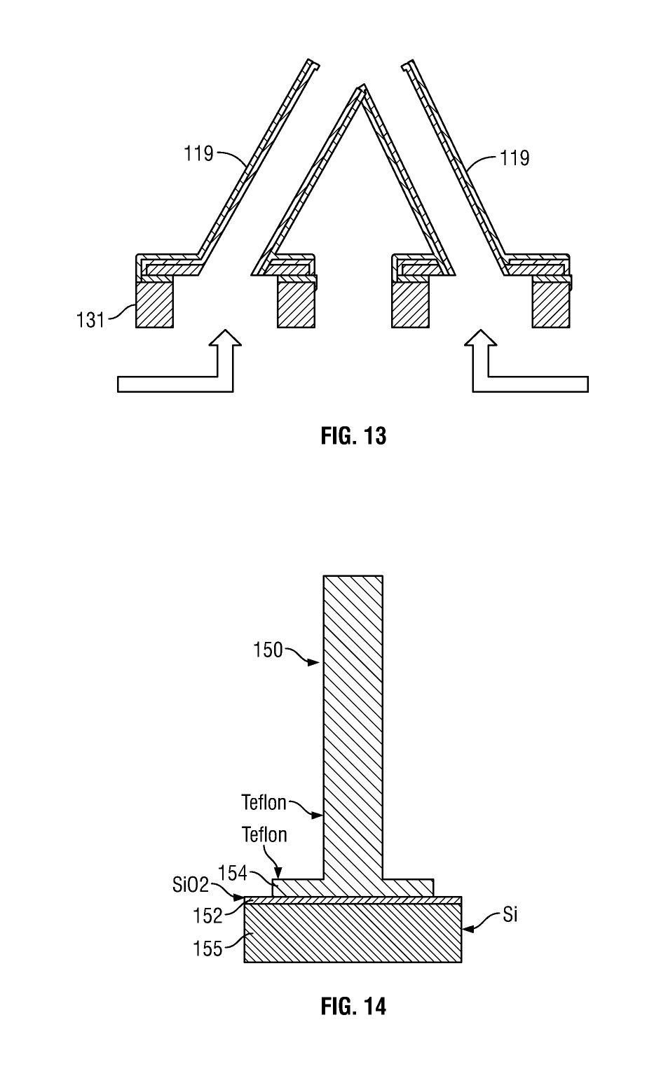

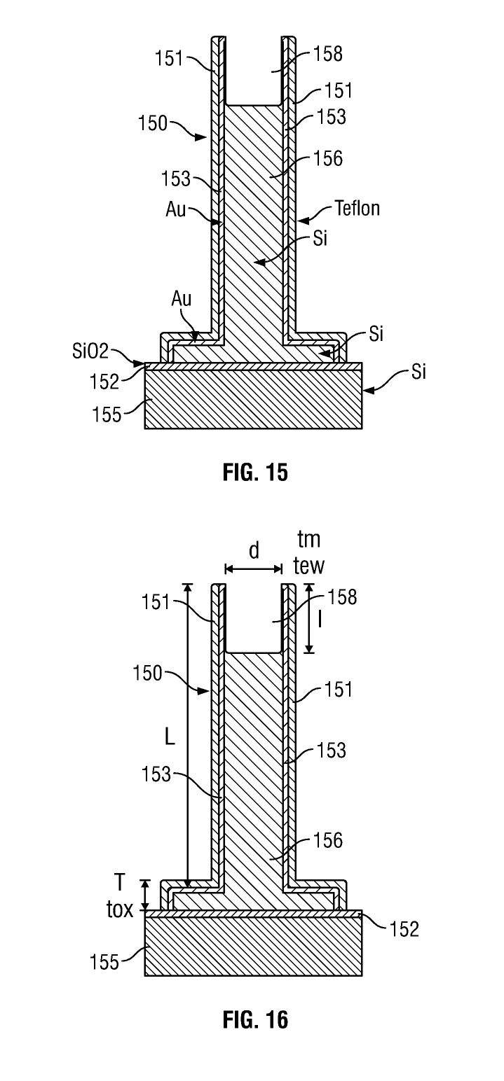

As also previously mentioned, the nanowires 114 may be heterostructures that are formed from multiple material layers. The layers of the nanowires 114 may be distinct from each other with minimal cross-contamination, or the composition of the nanowires 114 may vary gradually from one layer to the next. FIG. 10 shows one example of a sensor in which the nanowires 114 each comprise three different material layers 115, 116 and 117 which are formed in sequential evaporation steps through the shadow mask 130. Likewise, FIGS. 11A and 11B shows the tip 118 of a nanostructure bridge 112 that includes in FIG. 11A a semiconductor sensor 121 as the uppermost layer of the tip 118 and an insulating layer 123 below the semiconductor sensor. The tip 118 in FIG. 11B includes a metal nano thermometer 125 as the uppermost layer of the tip 118, followed below by an insulator layer 127 and a layer 129 that serves as a metal nano-heater.

In general, the nanowires 114 may each be formed from a wide variety of different material combinations that are deposited in different sequences to form layered nanowires that, without limitation, may include any of the following illustrative sequences of layers: metal-semiconductor, semiconductor-metal, metal-metal, semiconductor-semiconductor, metal-insulator-semiconductor, metal-insulator-metal, metal-semiconductor-metal, semiconductor-insulator-semiconductor and semiconductor-insulator-metal. A nanowire formed from a heterostructure may incorporate a wide range of different heterojunctions including for example, a p/n junction, a p/p junction, an n/n junction, a p/i junction (where i refers to an intrinsic semiconductor), an n/i junction, an i/i junction, or the like. The junction may also be a Schottky junction in some embodiments.

The dielectric layer 134 that is employed in the shadow mask 130 and the dielectric layer 120 that forms the tapered support structure 124 on which the nanowires 114 are deposited may or may not be formed from the same materials. If they are formed from different materials, an etching process may be used in FIG. SI that removes the dielectric layer 134 of the shadow mask without removing the tapered support structure 124. This may be advantageous when the tapered support structure 124 is to remain in the final device to provide greater mechanical strength. Also, if the dielectric layers 134 and 120 are formed from the same materials, the etching process shown in FIG. SI that removes them can be a gas phase isotropic chemical etching or a wet chemical etching process. A critical point drying process, or the like, can be used to prevent the nanowire bridge structure from collapsing due to liquid evaporation if wet chemical etching is employed.

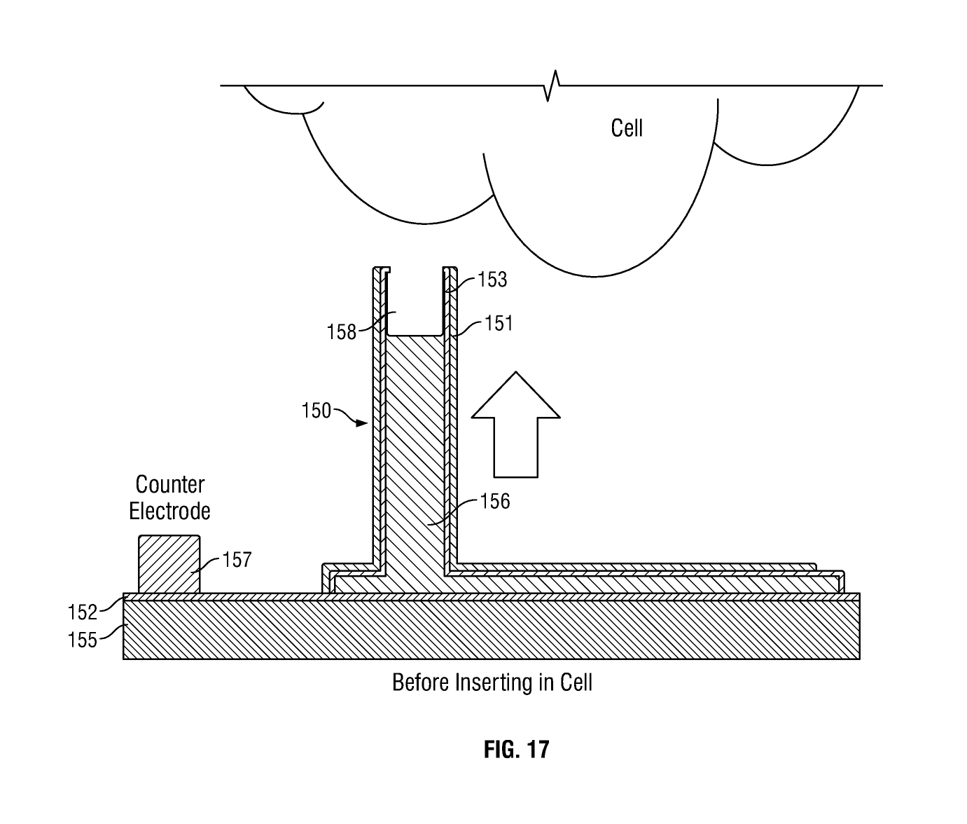

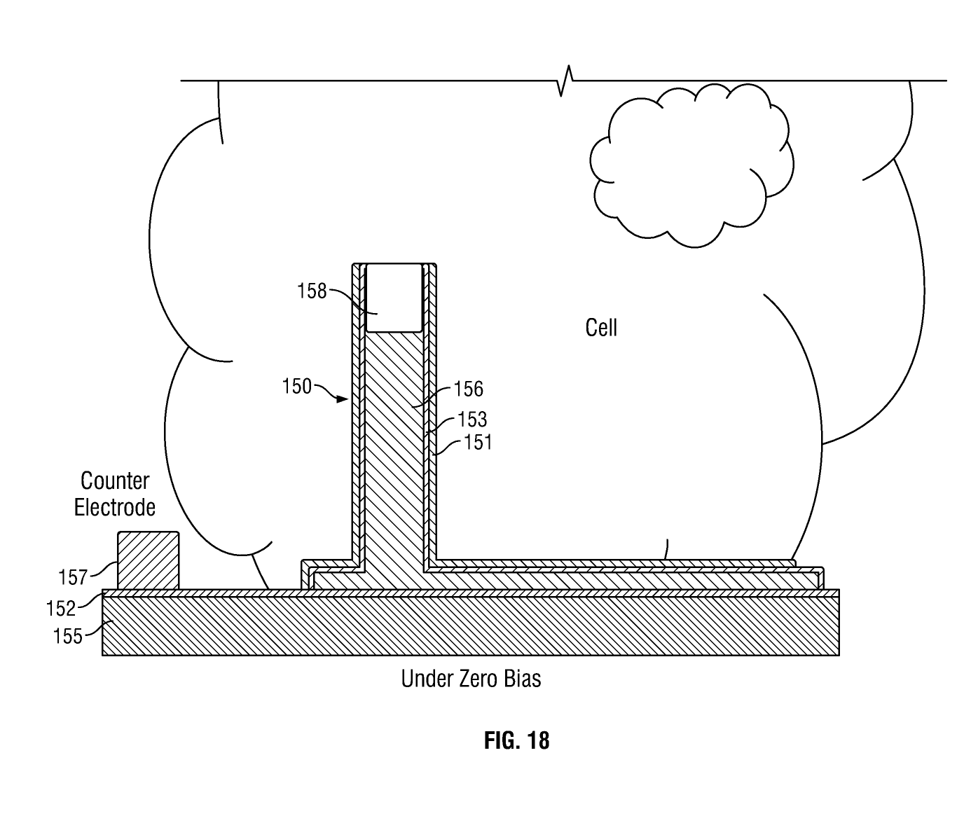

In some embodiments the nanowires 114 that define the nanowire bridge 112 may undergo further processing to form nanotubes that may be used to remove fluids from and/or deliver fluids to the cell or other sample with which the nanotubes communicate. This may be accomplished, for example, starting with the three layer nanowires shown in FIG. 10. In a first additional processing step at least the first two top layers 116 and 117 of the tip are removed using, for example, EMP or ion milling. Then, the middle layer 116 (e.g., Si or a metal oxide) is selectively removed using a chemical or other process. The resulting nanotubes 119 are shown in FIG. 12. In one particular embodiment shown in FIG. 13, the nanotubes may be bonded to a control stage 131 that allows the nanotubes to communicate with one or more microfluidic pumps, which may employ a micro-electromechanical system (MEMS) actuator or the like.

Among their other advantages the processes shown herein are compatible with CMOS fabrication processes, enabling the manufacturing of a large array of sensors on CMOS chips. Moreover, different patterns can be used for different areas of the shadow mask, giving rise to an array with different sensor configurations distributed over different parts of its surface, in contrast to the symmetric array of sensors shown in FIG. 4. Additionally, the use of flexible substrates may enable the fabrication of flexible or conformal sensor arrays that may be employed in many different applications. Furthermore, the supporting substrate 106 can be removed by etching process and the 3D sensor array network can be used as scaffolds for cell cluster and tissue engineering, or can be embedded in soft/flexible hosting materials, which can find broad applications in sensing and bioengineering.

The devices shown herein may be used in a wide variety of applications. For instance, they may be used as biosensors for drug screening, particularly for in-situ recording; as neuroprobes for multi-functional integrated detection systems with bio/chemo temperature, pressure and/or flow sensors; as photosensor arrays; as IR sensors or IR image sensor arrays by coating a thermometer probe with black coating and IR filter materials; as THz sensors or image sensor arrays; as floating gate structure transistor arrays with a liquid gate as gyro sensors; as E-nose arrays with TFT driving circuits or CMOS readout circuits; as a TFT with liquid gate for gyro sensors; as layered MIM devices for memory or tunneling devices for use as an electronics-neuron interface or a brain CNS interface. Other applications include their use in in-situ stem cell studies for intra cell signaling, pathway analysis/monitoring and modification/control, brain mapping, cancer tumor thermotherapy, electronic skin applications, and so on. Other applications may also employ layers such as MIM or MIIM antenna structures for energy harvesting. Furthermore, if the supporting substrate 106 is removed by an etching process the 3D sensor array network can be used as scaffolds for cell cluster and tissue engineering, or can be embedded in soft/flexible hosting materials, which can find applications, for example, in drug development, biological sensing, and electronic skin, brain mapping, cancer tumor thermotherapy, and so on.

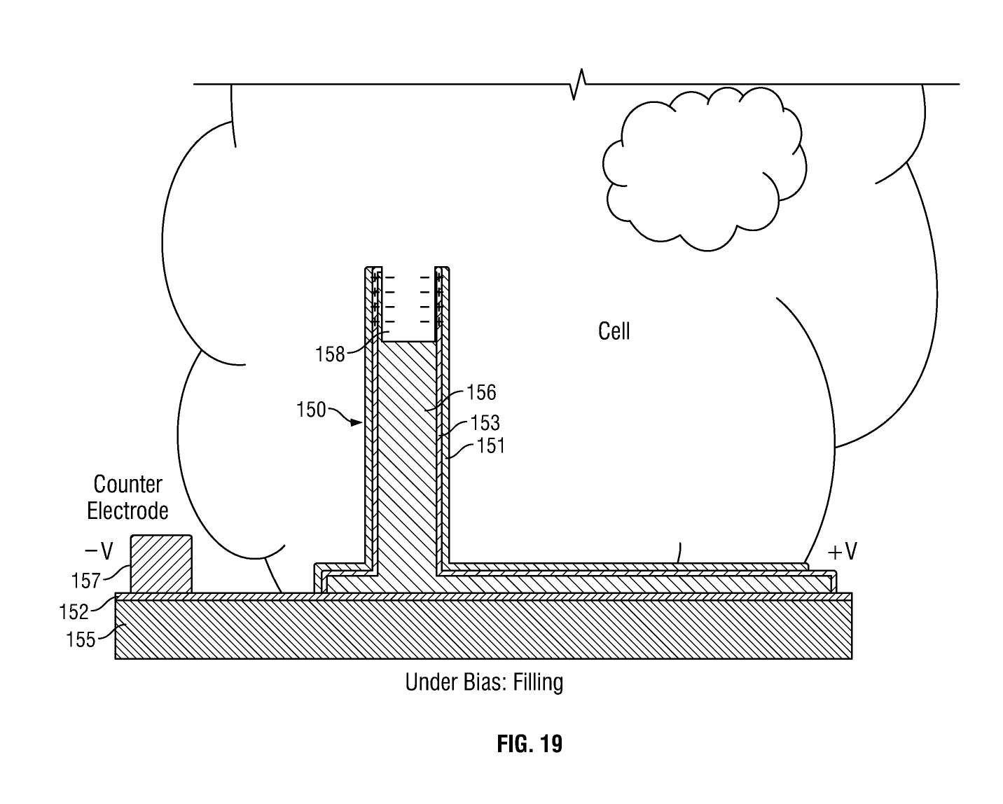

In accordance with another aspect of the invention, a single nanotube may be fabricated for use as a nano-needle and/or a nanopump that may be used, for example, to perform single cell biopsies. As shown in FIG. 14, the nano-needle 150 may be formed on a Si CMOS or polymer substrate 155. A dielectric 152 or other layer may be formed on the substrate, over which the base 154 of nano-needle 150 may be formed. As the figure indicates, a fluoropolymer (e.g., Teflon) or other hydrophobic (e.g. hydrophobic or superhydrophobic polymers) coating may be applied onto the outer surface of the nanotube. The coating may comprise one or more thin films that can be formed, for example, by vapor deposition or solution chemical reactions.

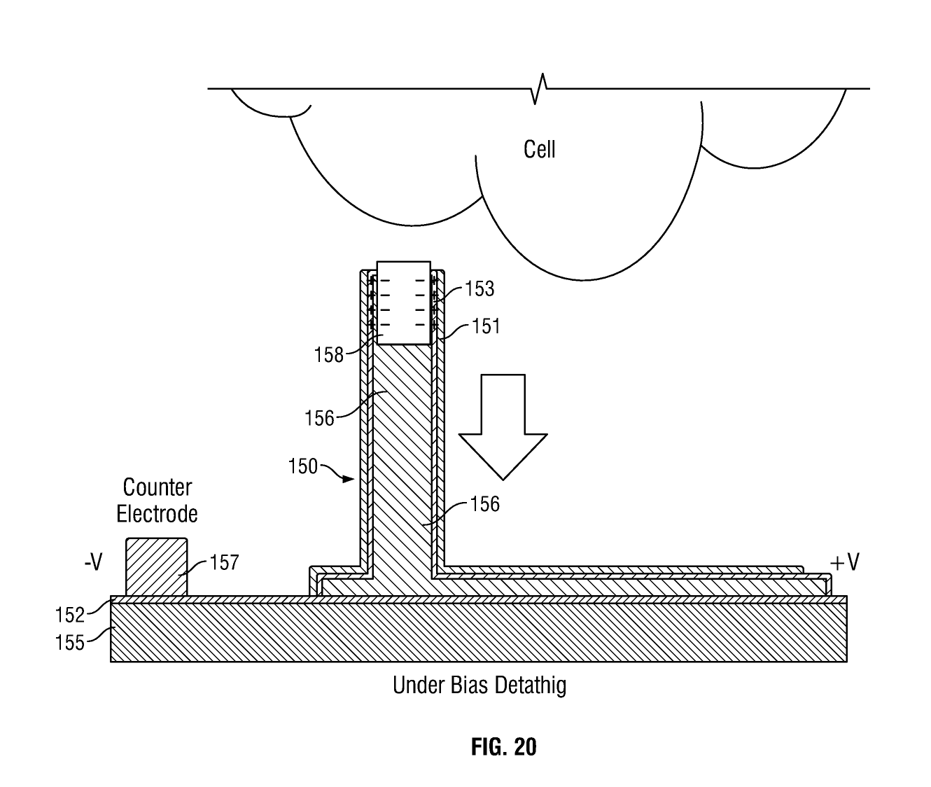

FIG. 15 shows a cross-section view of the nano-needle 150 in which the interior of the nanotube is visible. The walls 153 of the nano-needle 150 may be formed from any of the aforementioned materials from which the nanowires may be fabricated. In one particular embodiment the nanotube walls 153 may be formed from a metal such as gold, silver, copper or titanium. The interior of the nanotube may be partially filled with a suitable material such as silicon 156. The remaining interior portion of the nanotube may be used as a reservoir 158 into which a fluid or other material may be drawn from a cell or other sample being interrogated.

Various dimensional parameters of the nanotube are illustrated in FIG. 16. Illustrative values for these parameters in some embodiments are as follows. The length L and diameter d of the nano-needle 150 may range from 1,000-50,000 nm and 50-200 nm, respectively. The length I of the open reservoir 158 portion of the nano-needle 150 may range from 500-50,000 nm. The thickness T of the base 154 of the nano-needle 150 may range from 500-1,000 nm. The thickness tm of the walls 153 defining the nano-needle 150 may range from 50-200 nm and the thickness of the outer coating 151 that serves as a hydrophobic layer is 50-100 nm. In other applications, such as body fluidic testing applications, the dimensions can be larger. For instance, for such applications the length L and diameter d of the needle 150 may range from 50,000-1,000,000 nm and 1,000-250,000 nm, respectively.

In some embodiments a nanopump can be constructed from the nano-needle by coupling it to micro valves, microfluidic channels, MEMS pumps, and control circuitry.

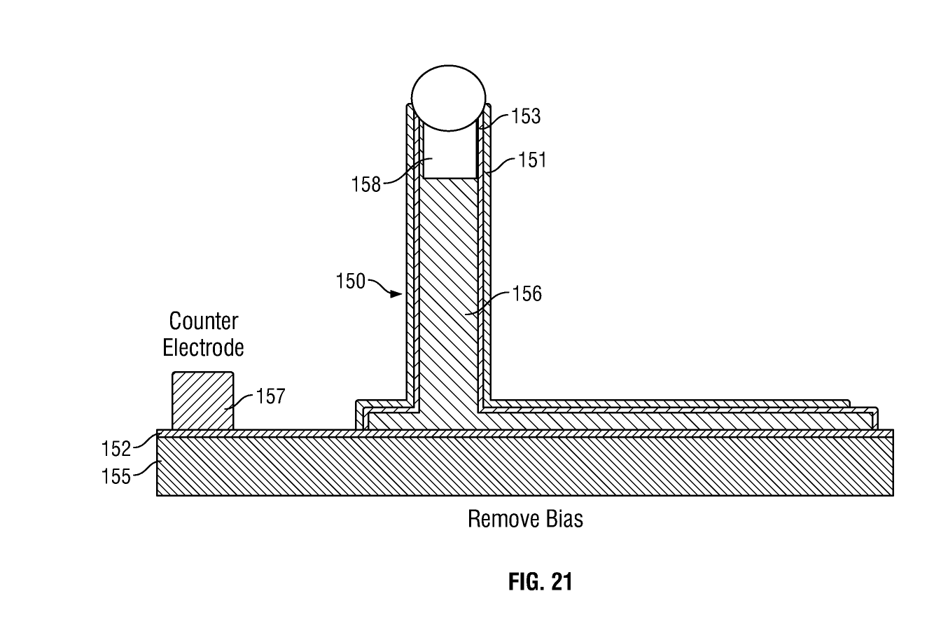

As shown in FIG. 17 a counter electrode 157 may be formed on the dielectric layer 152 of the substrate 155. In this way a voltage may be applied between the nano-needle 150 and the counterelectrode 157. The voltage can be used to control the intake and ejection of fluid from the nano-needle 150. In operation, the nano-needle 150 may be inserted into a cell or other sample as shown in FIG. 18. Since the outer surface of the nano-needle 150 is generally hydrophilic, little to no fluid will enter the nano-needle 150. Next, as shown in FIG. 19 a bias may be applied between the nano-needle 150 and the counterelectrode 157. As a result a positive charge is established on the metal layer 153 that forms the nano-needle 150 and fluid is drawn into the reservoir 158 of the nano-needle 150 by the electrowetting effect as well as capillary action. The nano-needle 150 may then be withdrawn from the cell while the bias continues to be applied (see FIG. 20). The bias may then be removed from the nano-needle 150, causing the fluid to be expelled from the nano-needle 150 as shown in FIG. 21 as a result of capillary action and the hydrophobic nature of its outer surface.

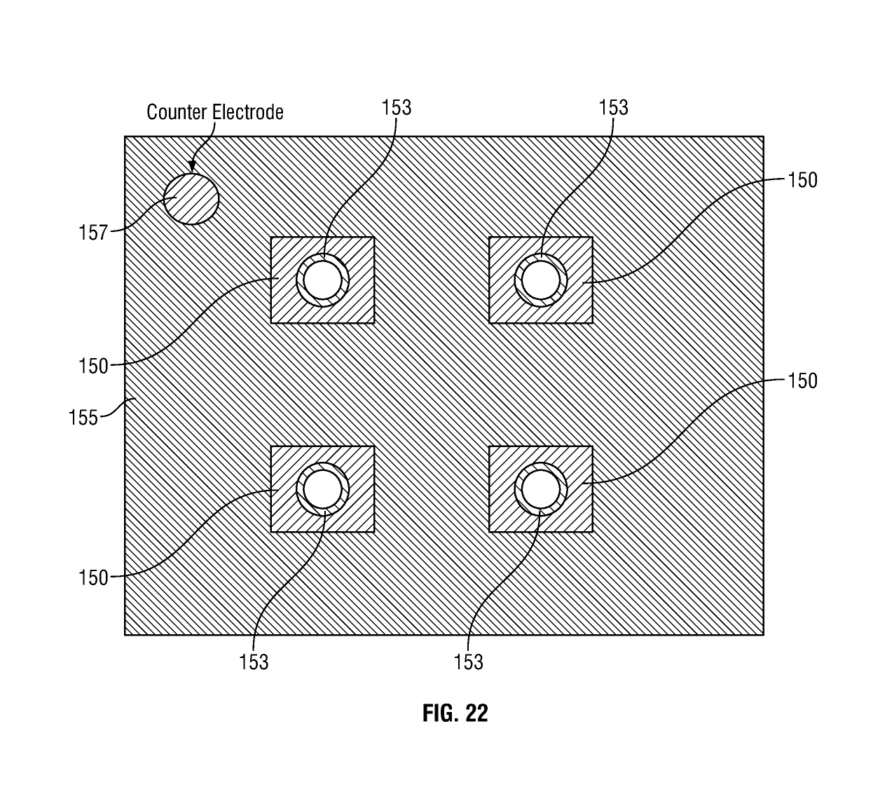

FIG. 22 is a top view of an array of nano-needles 150 of the type described above, which may be formed on a single substrate or wafer 155. The individual nano-needles 150 may be individually electrically addressable by controlling the voltage between the metal wall defining the nanopumps 150 and the counterelectrode 157.

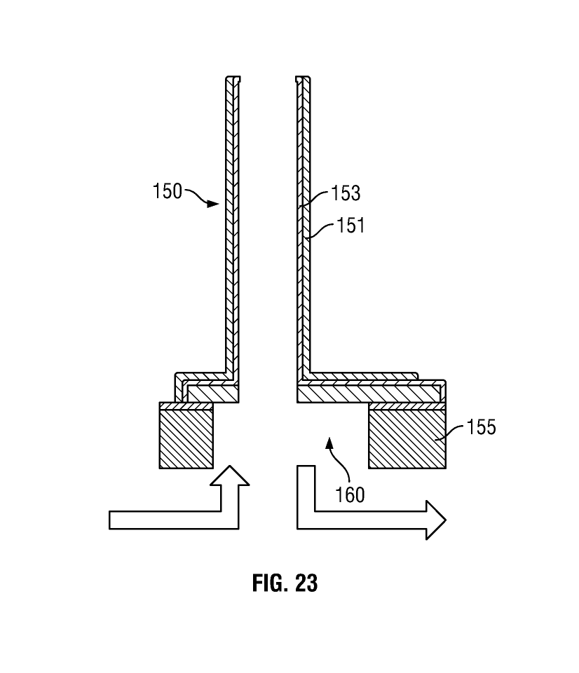

In some implementations such as shown in FIG. 23 the entire nano-needle 150 may be hollow, with its base being exposed to one or more channels 160 that are formed in the substrate 155. In this way the nano-needle 150 may be used to deliver to the cell or other sample fluids such as chemicals, drugs, growth factors, genes, proteins and the like. The nano-needle 150 may be connected to a microfluidic pump (not shown) via the channel 160 so that it may be used, for example, as a nano-nozzle for delivery of aqueous and/or oil-based inks or for applications such as 3D nano-printing.

In some embodiments, a large number of nano-needles 150 may be fabricated and connected to microfluidic pumps, which can be individually controlled to pumping fluids in and out of a cell membrane, skin or other sample in a temporal and spatially resolved manner, which can lead to applications in drug screening and development, drug delivery, brain mapping, stem cell research, tissue engineering and organ development, biological fluidic monitoring, and so on.

1. A nanoscale probe, comprising:
a substrate; and
a pair of nanoscale wires each having a first end disposed on the substrate and a second end, the second ends of each nanoscale wire being in contact with one another such that the pair of nanoscale wires form a bridge extending over the substrate.

2. The nanoscale probe of claim 1 wherein the substrate includes a pair of electrodes disposed on a surface of the substrate, each of the first ends of the nanoscale wires being located on one of the electrodes and being in electrical communication therewith.

3. The nanoscale probe of claim 2, further comprising at least one electronic device formed in the substrate, the electronic device being in electrical communication with the electrodes.

4. The nanoscale probe of claim 3, wherein the electronic device includes a microprocessor.

5. The nanoscale probe of claim 1, wherein the pair of nanoscale wires comprises a plurality of pairs of nanoscale wires, each of the pairs of nanoscale wires defining an individual sensor.

6. The nanoscale probe of claim 1, wherein at least one of the nanowires comprises silicon.

7. The nanoscale probe of claim 1, wherein at least one of the nanowires comprises a metal.

8. The nanoscale probe of claim 5, wherein the individual sensors collectively define an array of sensors disposed on the substrate.

9. The nanoscale probe of claim 1, wherein the nanoscale wires in the pair of nanoscale wires are formed from a common material or materials.

10. The nanoscale probe of claim 1, wherein the nanoscale wires in the pair of nanoscale wires are formed from at least one different material from one another.

11. The nanoscale probe of claim 1, further comprising a nanoscale support structure disposed on the substrate and being disposed under the bridge, the nanoscale wires being located on the support structure.

12. The nanoscale probe of claim 11, wherein the support structure has a tapered shape that conforms to a shape of the bridge such that the nanowires are in contact with the support structure along an entirety of their respective lengths.

13. The nanoscale probe of claim 1, wherein each of the nanoscale wires comprise a heterostructure.

14. The nanoscale probe of claim 1, wherein each of the nanoscale wires comprise a layered structure that includes a plurality of layers formed from different materials.

15. The nanoscale probe of claim 14, wherein the different materials are selected from the group consisting of a metal, a semiconductor and an insulator.

16. The nanoscale probe of claim 1, wherein the substrate is semiconductor substrate.

17. The nanoscale probe of claim 1, wherein the substrate is a CMOS substrate.

18. The nanoscale probe of claim 1, wherein the substrate is a flexible substrate.

19. The nanoscale probe of claim 5, wherein each of the sensors is independently and selectively addressable by the electronic device.

20. A method of forming a nanoscale probe, comprising:
forming a dielectric layer on a substrate;
applying a photoresist mask over the substrate;
performing an isotropic etch on the dielectric layer such that a remaining portion of the dielectric layer defines a tapered support structure located under the photoresist mask;
removing the photoresist mask and applying a shadow mask over the tapered support structure, the shadow mask having at least a first pair of nanoscale apertures that are aligned with respect to the tapered support structure such that material deposited through each of the nanoscale apertures form a nanoscale wire on a different surface of the tapered support structure; and
depositing material through the nanoscale apertures to form the first pair of nanoscale wires.

21. The method of claim 20, wherein the substrate includes a pair of electrodes located on the substrate and the photoresist mask is aligned so that after performing the isotropic etch a base of the tapered structure extends over a portion of each electrode in the pair.

22. The method of claim 20, further comprising performing an etching step to remove the shadow mask and the tapered support structure and a critical point drying process.

23. The method of claim 20, wherein the nanoscale wires have end portions that contact one another at an apex of the tapered support structure so that the nanoscale wires define a bridge extending over the substrate.

24. The method of claim 20, wherein depositing material through the nanoscale apertures to form the first pair of nanoscale wires includes depositing at least a first material through a first of the apertures to form a first of the nanoscale wires and depositing at least a second material through a second of the apertures to form a second of the nanoscale wires, the first and second materials being different from one another.

25. The method of claim 20, wherein depositing material through the nanoscale apertures to form the first pair of nanoscale wires includes sequentially depositing a plurality of materials through at least one of the apertures to form a layered heterostructure nanowire.

26. The method of claim 23, wherein depositing material through the nanoscale apertures to form the first pair of nanoscale wires includes sequentially depositing a plurality of materials through at least one of the apertures to form a layered heterostructure nanowire.

27. The method of claim 26, wherein the layered heterostructure nanowires in the first pair each include first and second outer layers and at least one interior layer and further comprising:
etching a tip of the bridge to expose at least one of the interior layers; and
selectively removing the at least one of the interior layer from each of the nanoscale wires to thereby form a pair of nanotubes.

28. The method of claim 20, wherein performing the isotropic etch includes performing the isotropic etch on the dielectric layer such that a remaining portion of the dielectric layer defines a plurality of tapered support structures, and further wherein the shadow mask has a plurality of pairs of nanoscale apertures that are aligned with respect to the plurality of tapered support structures such that material deposited through each of the pairs of nanoscale apertures form a pair of nanoscale wires on one of the tapered support structures, each of the pair of nanoscale wires defining a nanoscale bridge extending over the substrate and further comprising depositing material through the nanoscale apertures to form the pairs of nanoscale wires.

29. The method of claim 20, wherein depositing the material includes depositing the material using an evaporation process.

30. A nanoscale needle and nanopump, comprising:
a substrate;
a dielectric layer disposed on the substrate;
a conductive nanotube having a base disposed on the dielectric layer and an opening disposed at an end of the conductive nanotube remote from the base such that the opening is adapted to be in fluidic communication with a sample;
a hydrophobic coating disposed on an outer surface of the conductive nanotube; and
an electrode disposed on the dielectric layer and spaced apart from the conductive nanotube.

31. The nanoscale needle of claim 30, further comprising a material partially filling an interior of the conductive nanotube such that a reservoir remains in the interior between the material and the opening of the nanotube.

32. The nanoscale needle of claim 31, wherein the material comprises silicon.

33. The nanoscale needle of claim 30, wherein the hydrophobic material comprises a fluoropolymer.

34. The nanoscale needle of claim 30, wherein the conductive nanotube comprises a plurality of conductive nanotubes disposed on the dielectric layer, each of the conductive nanotubes being individually selectively addressable by controlling a voltage between the electrode and each of the conductive nanotubes.

35. The nanoscale needle of claim 30, further comprising a microfluidic pump in fluidic communication with the base of conductive nanotube for delivering fluids therethrough.

36. The nanoscale needle of claim 35, wherein the microfluidic pump is disposed in or on the substrate.

37. A method for extracting fluid from a sample using a nano-needle, comprising:
inserting into a sample a nanotube having a conductive sidewall and a hydrophobic coating disposed on the conductive sidewall such that an opening of the nanotube is in fluidic communication with an interior of the sample;
after the nanotube is inserted, applying a bias between the conductive sidewall and a counter-electrode such that fluid is drawn into an interior of the nanotube through the opening at least in part in accordance with an electrowetting effect;
while the bias continues to be applied, withdrawing the nanotube from the sample after the fluid is draw into the interior; and
removing the bias to thereby expel the fluid from the interior of the nanotube.

38. The method of claim 37, wherein the sample is a biological sample.

39. The method of claim 38, wherein the biological sample is a cell.
